(19) United States
(12) Patent Application Publication
(10) Pub. No.: US 2015/0369160 A1
(43) Pub. Date: Dec. 24, 2015

(54) METHOD OF CONTROLLING INJECTION PRESSURE LEVEL IN UNIT INJECTORS

(71) Applicant: Caterpillar Inc., Peoria, IL (US)

(72) Inventors: Derek A. Tanis, Peoria, IL (US); Christopher J. Hurley, Peoria, IL (US); Derek E. Nieman, Peoria, IL (US); Ramamurthy Vaidyanathan, Peoria, IL (US)

(73) Assignee: Caterpillar Inc., Peoria, IL (US)

(21) Appl. No.: 14/838,368

(22) Filed: Aug. 28, 2015

(51) Int. Cl. F02D 41/30; F02M 57/02; F02M 63/00; F02M 61/04

(52) U.S. Cl. CPC F02D 41/3005; F02M 61/04; F02M 57/024; F02M 63/0015

(57) ABSTRACT

A method to control an injection pressure level of fuel within a unit injector is provided. The method includes provision of a second spill valve in the unit injector, which is connected in parallel to a first spill valve. The fuel is delivered to the unit injector with the first spill valve maintained in a passive state. This facilitates return of the first portion of the fuel to the low-pressure fuel manifold. The first spill valve is actuated to an active state to block the flow of fuel to the low-pressure fuel manifold, to maintain the unit injector at the injection pressure level. The second spill valve is actuated concurrently or prior to the actuation of the first spill valve. This facilitates return of a second portion of the fuel to the low-pressure fuel manifold. This is done to limit the injection pressure level within the unit injector.

### TECHNICAL FIELD

The present disclosure generally relates to a mechanical electronic unit injector. More particularly, the present disclosure relates to a method to control an injection pressure level in such a mechanical electronic unit injectors.

### BACKGROUND

Mechanically actuated electronically controlled unit injectors (MEUI) have seen great success in compression ignition engines for many years. In recent years, MEUI injectors have acquired additional control capabilities via a spill valve actuated by a first solenoid and a nozzle check valve actuated by a second solenoid. MEUI fuel injectors may be actuated via rotation of a cam, which may be typically driven by a gear linkage to the crankshaft of an engine. The cam may rotate to move a plunger housed within the MEUI fuel injector, and the fuel may be initially displaced to a drain at low pressure for recirculation, via the spill valve. The spill valve may be closed to increase fuel pressure in the MEUI fuel injector. Fuel injection commences by energization of the second solenoid. This is performed to relieve pressure so that the nozzle check valve opens. The nozzle check valve can be opened and closed number of times to create an injection sequence that includes a number of injection events. These multi-nozzle injection sequences have been developed as one strategy to burn the fuel in a manner that reduces the production of undesirable emissions.

A general requirement to limit the peak injection pressure level on engines operating at high brake mean effective pressure (BMEP), which require long injection durations, to give high power that may lead to high injection pressures. There is a general need to limit the peak injection pressure level to optimize injection duration of fuel, owing to the heightened injection pressure, and, thereafter, and reduce the level of consequential emissions. However, the inherent structure and function of the MEUI injectors make it difficult to control peak injection pressure levels in an injection sequence. This is because the fuel pressure is primarily dictated by plunger speed (or engine speed) and the flow area of the nozzle outlets. Therefore, there are limitations in the appropriate control of injection profiles of the fuel during an injection event.

U.S. Pat. No. 6,371,088 relates to a fuel system with a self-relieving fuel filter assembly. The self-relieving fuel filter assembly communicates with a return line and is variable between a first state and a second state. In both the states, fuel passes through the return line, and, therefore, permits a passage of the fuel to a fuel tank. However, the 088′ reference is focused towards an externally positioned fuel filter assembly relative to a fuel injector that has pressure based self-relieving capabilities, and provides no solution to the control of peak injection pressure sustained within the fuel injector.

The present disclosure seeks to address one or more of the problems associated with the above.

### SUMMARY OF THE INVENTION

Various aspects of the present disclosure relate to a method to control an injection pressure level of fuel within a unit injector. The unit injector includes a first spill valve. The first spill valve is configured to allow return of a first portion of the fuel from the unit injector to a low-pressure fuel manifold. The method includes provision of a second spill valve in the unit injector, which is connected in parallel to the first spill valve. The second spill valve includes at least one of a controlled orifice or a fixed orifice. The fuel is delivered to the unit injector, with the first spill valve maintained in a passive state. This facilitates return of the first portion of the fuel to the low-pressure fuel manifold. The first spill valve is actuated to an active state to block flow of the fuel to the low-pressure fuel manifold. Thus, the fuel is maintained at a level approximate to the injection pressure level within the unit injector. The second spill valve is actuated concurrently or prior to the actuation of the first spill valve. This facilitates return of a second portion of the fuel to the low-pressure fuel manifold to limit the injection pressure level within the unit injector.

### BRIEF DESCRIPTION OF THE DRAWINGS

FIG. 1 is a cross-section of an injector system with a unit injector, in accordance with the concepts of the present disclosure;

FIG. 2 is a diagrammatic view of a cross-sectional profile of the unit injector of FIG. 1 in conjunction with a controller, in accordance with the concepts of the present disclosure;

FIG. 3 is a block diagram of the injector system of FIG. 1, in accordance with the concepts of the present disclosure; and

FIG. 4 is a flow chart of a method to control an injection pressure level in the unit injector, in accordance with the concepts of the present disclosure.

### DETAILED DESCRIPTION

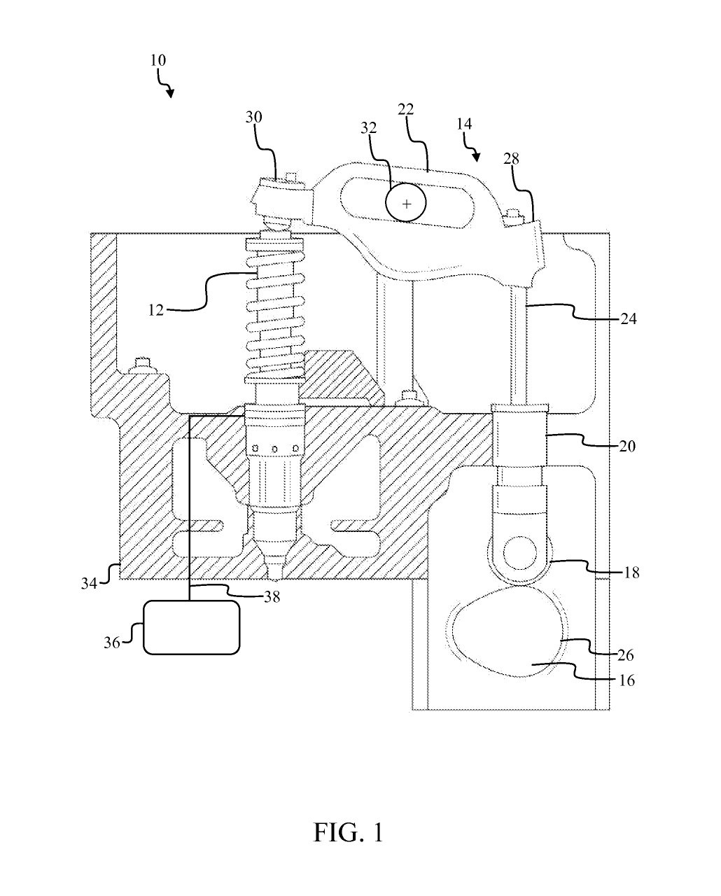

Referring to FIG. 1, there is shown an injector system 10 applied in an internal combustion engine (not shown). The injector system 10 includes a unit injector 12 and a cam arrangement 14. The unit injector 12 may embody a mechanically operated pump-type unit fuel injector. The unit injector 12 is driven by the cam arrangement 14, to selectively pressurize fuel within the unit injector 12 to a desired pressure level. The cam arrangement 14 includes a cam 16, a follower 18, a hydraulic lash adjuster 20, a rocker arm 22, and a push rod 24. The cam 16 includes a cam lobe 26, which acts as a driving surface. The cam 16 is operatively connected to a crankshaft (not shown), such that a rotation of the crankshaft (not shown) corresponds to the rotation of the cam 16. The cam 16 is in contact with the follower 18, such that the cam lobe 26 rotatably drives the follower 18, and subsequently results in a collective linear movement of the follower 18 and the push rod 24. The follower 18 is attached to the hydraulic lash adjuster 20. The hydraulic lash adjuster 20 is implemented between the cam lobe 26 and the push rod 24. One end of the push rod 24 is attached to the hydraulic lash adjuster 20 and other end is attached to the rocker arm 22.

The rocker arm 22 includes a first end 28 and a second end 30. The first end 28 is a push rod receiving portion, which is attached to the push rod 24. The second end 30 is a valve actuation contact portion, which facilitates operation of the valves of the associated cylinders of the engine (not shown). The rocker arm 22 includes a rocker shaft 32, about which the rocker arm 22 may pivot, during operations.

The unit injector 12 is disposed within a cylinder head 34 and is connected to a low-pressure fuel manifold 36 by way of a number of fuel lines 38. The low-pressure fuel manifold 36 supplies the fuel to the unit injector 12. The unit injector 12 may include multiple components that interact to pressurize and inject fuel into a combustion chamber (not shown), in response to the driving motion of the cam arrangement 14. These components are laid out below by way of an elaborated discussion.

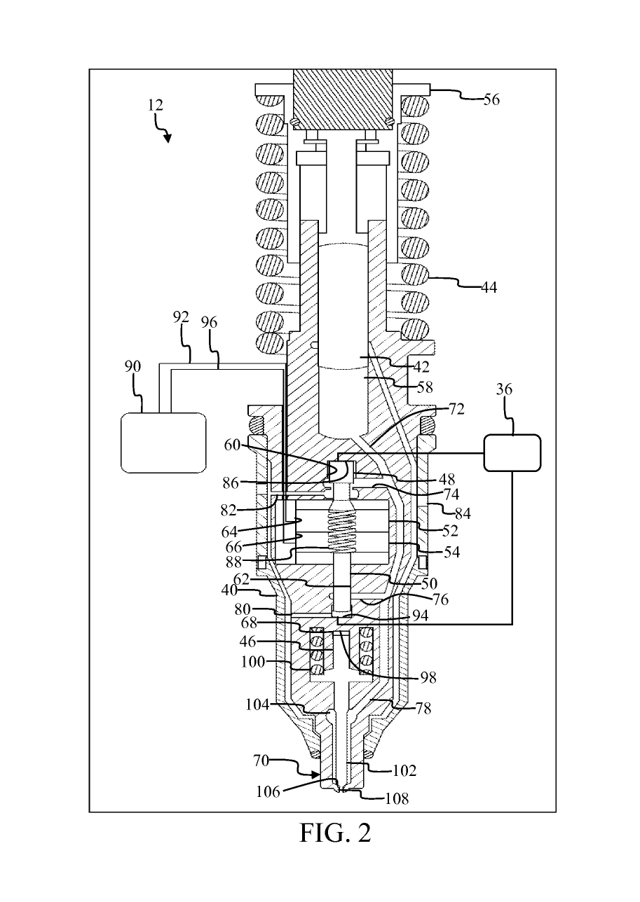

Referring to FIG. 2, there is shown the unit injector 12 of FIG. 1. The unit injector 12 includes an injector body 40, a plunger 42, a compression spring 44, a needle valve 46, a first spill valve 48, a second spill valve 50, a first solenoid 52, and a second solenoid 54. It may be contemplated that additional components may be included within the unit injector 12, such as restricted orifices, pressure-balancing fluid passageways, accumulators, and/or other injector components known in the art, but which are not shown for clarity.

The injector body 40 may be a generally cylindrical member. The injector body 40 includes a multiple components that together define several fluid passages and chambers. More specifically, the injector body 40 includes a tappet 56, a fuel pressurization chamber 58, a first spill valve bore 60, a second spill valve bore 62, a first solenoid bore 64, a second solenoid bore 66, a needle valve bore 68, a nozzle portion 70, fluid passages 72, 74, 76, 78, 80, 82 and a return fluid passage 84.

The tappet 56 is positioned at a relatively top portion of the unit injector 12 and is in operable engagement with the second end 30 of the rocker arm 22 (FIG. 1). The tappet 56 is connected to the plunger 42 to ascertain a reciprocal movement of the plunger 42. Further, the compression spring 44 is positioned against the injector body 40 and is provided to urge the tappet 56 upward relative to the injector body 40.

The fuel pressurization chamber 58 is defined between the injector body 40 and bottom face of the plunger 42. The fuel pressurization chamber 58 is structured along a length of the injector body 40 and accommodates a reciprocal or a slidable movement of the plunger 42 within the fuel pressurization chamber 58.

The plunger 42 is slidably disposed within the fuel pressurization chamber 58 and is movable by the rocker arm 22 to pressurize fuel within the fuel pressurization chamber 58. The fuel pressurization chamber 58 may be selectively in fluid communication with the first spill valve 48, the second spill valve 50, and the nozzle portion 70, via the fluid passages 72, 74, 76, and 78.

The first spill valve bore 60 is disposed below the fuel pressurization chamber 58, along a height of the unit injector 12. The first spill valve bore 60 houses the first spill valve 48. The first spill valve bore 60 is fluidly connected to the fuel pressurization chamber 58, via the fluid passages 72 and 74. In addition, the first spill valve bore 60 is fluidly connected to the low-pressure fuel manifold 36, via the fluid passage 82 and the return fluid passage 84. The first spill valve 48 is forced against a first seat surface 86 by action of a spring 88.

The first spill valve 48 is operably connected to the first solenoid 52. The first solenoid 52 is accommodated in the first solenoid bore 64, which is disposed below the first spill valve bore 60. The first solenoid 52 is connected to a controller 90, via a first communication line 92. The first spill valve 48 is in fluid communication with the low-pressure fuel manifold 36. In a passive state, the first spill valve 48 drains the fuel from the unit injector 12 to the low-pressure fuel manifold 36. In an active state, the first spill valve 48 blocks drainage of the fuel from the unit injector 12 to the low-pressure fuel manifold 36.

The second spill valve bore 62 is provided below the first spill valve bore 60, along a height of the unit injector 12. The second spill valve bore 62 houses the second spill valve 50. The second spill valve 50 is fluidly connected to the fuel pressurization chamber 58, via the fluid passages 72 and 76. The second spill valve 50 is fluidly connected to the low-pressure fuel manifold 36, via the fluid passage 80 and the return fluid passage 84. The second spill valve 50 is forced against a second seat surface 94 by action of the spring 88.

The second solenoid 54 is operably connected to the second spill valve 50. The second solenoid 54 is placed in the second solenoid bore 66, which is disposed between the first solenoid bore 64 and the second spill valve bore 62. The second solenoid 54 is connected to the controller 90 via a second communication line 96. The second spill valve 50 is connected in parallel to the first spill valve 48. The second spill valve 50 includes an orifice 110. The orifice 110 may be a controlled orifice or a fixed orifice. The controlled orifice varies the flow of the fuel drained through the second spill valve 50. The second spill valve 50 may also include a fixed orifice, in other embodiments. The fixed orifice allows constant flow of the fuel drained through the second spill valve 50. In the active state, the second spill valve 50 drains the fuel from the unit injector 12 to the low-pressure fuel manifold 36. In the passive state, the second spill valve 50 blocks drainage of the fuel from the unit injector 12 to the low-pressure fuel manifold 36.

The needle valve bore 68 is structured sequentially below the first spill valve bore 60 and the second spill valve bore 62, along a height of the unit injector 12, and extends all the way to the nozzle portion 70. The needle valve bore 68 houses the needle valve 46.

The needle valve 46 rests against a third seat surface 98 by action of a needle valve spring 100. The needle valve 46 also includes a tip portion 102 that is housed in the nozzle portion 70.

The nozzle portion 70 may embody a generally cylindrical structure applicable to deliver a quantity of fuel into at least one of a pre-combustion chamber or a main combustion chamber of the associated cylinder of the engine (not shown). The nozzle portion 70 includes a nozzle chamber 104, a valve seat 106, and an outlet 108.

The nozzle chamber 104 receives the tip portion 102 of the needle valve 46 substantially adequately so as to complement the outer profile of the tip portion 102 with an inner profile of the nozzle portion 70. The tip portion 102 is held against the valve seat 106 in a closed position by a default action of a needle valve spring 100. The nozzle chamber 104 is in direct communication with the needle valve 46. The nozzle chamber 104 is fluidly connected to the fuel pressurization chamber 58, via the fluid passages 72 and 78. The nozzle chamber 104 is selectively drained of, or supplied with, an amount of pressurized fuel. This arrangement affects the motion of the needle valve 46 with respect to the valve seat 106. The motion of the needle valve 46, with respect to the valve seat 106, opens or closes the outlet 108 to control the flow of the fuel from the nozzle chamber 104 into the combustion chamber (not shown).

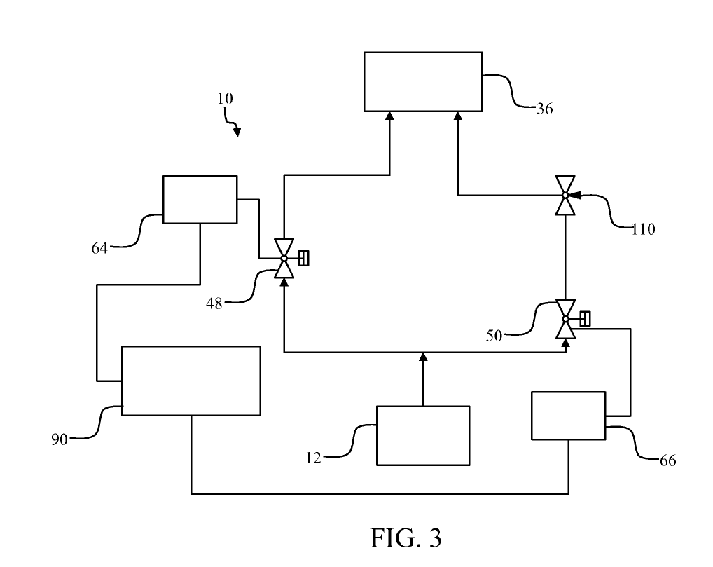

Referring to FIG. 3, there is shown a block diagram of the injector system 10 with the controller 90, the low-pressure fuel manifold 36, the first solenoid 52, the second solenoid 54, the first spill valve 48, and the second spill valve 50.

The controller 90 is in control communication with the first solenoid 52 and the second solenoid 54. The controller 90 may be a microprocessor-based unit adapted to perform set functions based upon a received input pertaining to the delivery of the amount of fuel into the combustion chamber. As an example, this delivery information may be stored in an in-built memory. Optionally, the controller 90 may be integrated with the ECM of the associated engine, although it is contemplated that the controller 90 is a stand-alone entity.

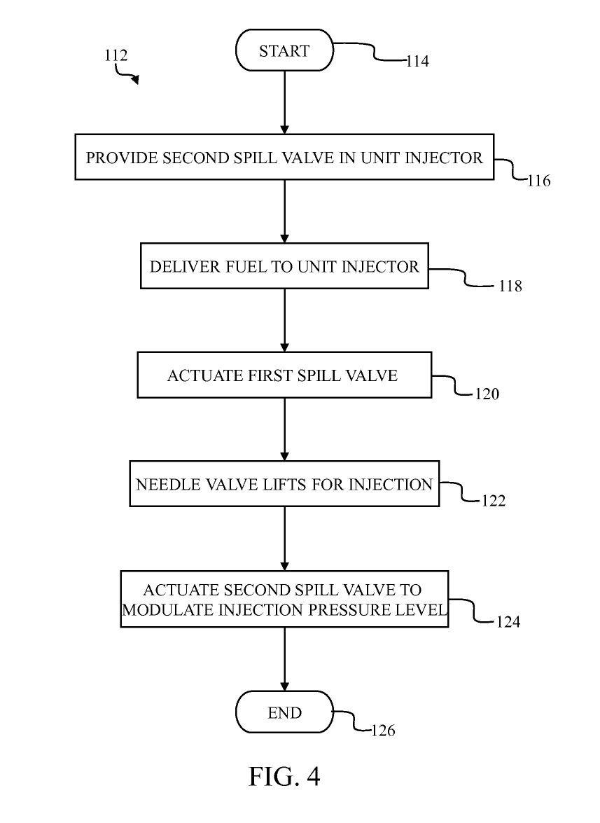

Referring to FIG. 4, there is shown a flow chart for a method 112 to control an injection pressure level of the fuel within the unit injector 12. The method 112 starts at step 114 and proceeds to step 116.

At step 116, the second spill valve 50 is provided parallel to the first spill valve 48 in the unit injector 12. The method 112 proceeds to step 118.

At step 118, the plunger 42 shifts in an upward direction in the fuel pressurization chamber 58 via pivotal movement of the rocker arm 22. This results in a delivery of the fuel from the low-pressure fuel manifold 36 to the unit injector 12. During fill-up of the unit injector 12, the first spill valve 48 and the second spill valve 50 are in the passive state, and the needle valve 46 is forced to be in a closed position. The passive state of the first spill valve 48 facilitates delivery of a first portion of the fuel to the low-pressure fuel manifold 36. Upon fill-up of the unit injector 12, the method 112 proceeds to step 120.

At step 120, the first spill valve 48 shifts to the active state by the first solenoid 52. This action blocks the drainage of the fuel from the unit injector 12 to the low-pressure fuel manifold 36. Simultaneously, a downward movement of the plunger 42 in the fuel pressurization chamber 58 pressurizes the fuel in the unit injector 12. The method 112 proceeds to step 122.

At step 122, while the fuel is pressurized by the movement of the plunger 42, pressure in the unit injector 12 reaches an injection pressure level. Upon attainment of the injection pressure level, the pressurized fuel acts on the tip portion 102 of the needle valve 46 and the needle valve 46 moves upwards against the needle valve spring 100. Thus needle valve 46 lifts to open the outlet 108. This initiates an injection event, in which the fuel is injected into the combustion chamber (not shown) at the injection pressure level. The method 112 proceeds to step 124.

At step 124, the controller 90 signals the second solenoid 54 to limit the injection pressure level at the time of an injection event. Thus, the second solenoid 54 actuates the second spill valve 50 to the activate state. This drains a second portion of the fuel from the unit injector 12 to the low-pressure fuel manifold 36. This reduces the pressure in the unit injector 12 and thus the fuel is injected at a pressure less than the injection pressure level. The method 112 proceeds to end step 126.

At end step 126, the first solenoid 52 and the second solenoid 54 de-energize the first spill valve 48 and the second spill valve 50, respectively, to the passive state. This ends the injection event.

### INDUSTRIAL APPLICABILITY

In operation, as the cam lobe 26 rotates, the rocker arm 22 pivots about the rocker shaft 32. As a result, the cam lobe 26 indirectly drives the first end 28 of the rocker arm 22 with the push rod 24. This results in actuation of the unit injector 12 by the second end 30 of the rocker arm 22. This may periodically cause reciprocating motion of the unit injector 12, via a pivoting rocker arm 22. When the rocker arm 22 pivots in a clockwise direction, the second end 30 moves away from the unit injector 12 and the plunger 42 moves in the upward direction. This draws in the fuel into the unit injector 12 and a fill operation of the unit injector 12 is initiated. During the filing operation, the first spill valve 48 and the second spill valve 50 are maintained in the passive state. The first spill valve 48 in the passive state is in contact with the first seat surface 86 and facilitates flow of the fuel to the low-pressure fuel manifold 36, via the return fluid passage 84. Similarly, the second spill valve 50 in the passive state, is in contact with the second seat surface 94 and blocks the flow of the fuel from the unit injector 12 to the low-pressure fuel manifold 36.

When the rocker arm 22 pivots in a counter-clockwise direction, the second end 30 pushes the plunger 42 in a downward direction inside the fuel pressurization chamber 58. Simultaneously, the controller 90 transmits a signal to the first solenoid 52 to energize the first spill valve 48 to the active state. In the active state, the first spill valve 48 reciprocates and moves away from the first seat surface 86. This blocks the flow of fuel from the unit injector 12 to the low-pressure fuel manifold 36. Hence, with negligible drainage of the fuel from the unit injector 12 and with the downward movement of the plunger 42, the fuel in the unit injector 12 is pressurized to the injector pressure level. This pressurized fuel acts on the needle valve 46 and urges the needle valve 46 to lift and initiate injection of the fuel at the injection pressure level.

When there is a need to limit the injection pressure level, at any point throughout the injection, the controller 90 signals the second solenoid 54 to actuate the second spill valve 50. As a result, the second spill valve 50 shifts to the active state and allows the second portion (such as a leak) of the fuel to drain to the low-pressure fuel manifold 36. This reduces the injection pressure level in the unit injector 12.

Hence, the disclosed unit injector 12 and method 112 to control injection pressure level, assists in the limitation of the injection pressure level, whenever desired. As the second spill valve 50 is provided to limit pressure throughout the injection event, cam modifications may be avoided and standardized component designs may be applied. Also, minimum modifications are required for the disclosed unit injector 12, as the injection pressure level is reduced via provision of the second spill valve 50. Thus, the cost effectiveness of the disclosed unit injector 12 is enhanced.

The many features and advantages of the disclosure are apparent from the detailed specification, and thus, are intended by the appended claims to cover all such features and advantages of the disclosure that fall within the true spirit and scope thereof. Further, since numerous modifications and variations will readily occur to those skilled in the art, it is not desired to limit the disclosure to the exact construction and operation illustrated and described herein. Accordingly, all suitable modifications and equivalents may be resorted to that fall within the scope of the disclosure.

What is claimed is:

1. A method of controlling an injection pressure level of fuel within a unit injector having a first spill valve, wherein the first spill valve is configured to allow return of a first portion of the fuel from the unit injector to a low-pressure fuel manifold, the method comprising:
providing a second spill valve in the unit injector connected in parallel to the first spill valve, wherein the second spill valve includes at least one of a controlled orifice or a fixed orifice;
delivering fuel to the unit injector, with the first spill valve being in a passive state, to facilitate delivery of the first portion of the fuel to the low-pressure fuel manifold;
actuating the first spill valve to an active state, and facilitating blockage of flow of the fuel to the low-pressure fuel manifold such that the fuel within the unit injector is maintained at about the injection pressure level; and
actuating the second spill valve to the active state at least concurrently or prior to the actuation of the first spill valve to facilitate delivery of a second portion of the fuel to the low-pressure fuel manifold to limit the injection pressure level within the unit injector.
